(19) United States
(12) Patent Application Publication
(10) Pub. No.: US 2006/0266242 A1
(43) Pub. Date: Nov. 30, 2006

(54) Method and device for cleaning a cylinder of a printing press

(76) Inventors: Angelo Bartesaghi, Lecco (IT); Roberto Perego, Moggio-Lecco (IT)

Correspondence Address: HEDMAN & COSTIGAN P.C., 1185 AVENUE OF THE AMERICAS, NEW YORK, NY, 10036, US

(21) Appl. No.: 10/558,954

(22) PCT Filed: Dec. 19, 2003
(86) PCT No.: PCT/EP03/01467

§ 371 Date: Nov. 30, 2005

(30) Foreign Application Priority Data
Jun. 5, 2003 (IT) MI2003 A 001131

(51) Int. Cl. B41F 35/00

(52) U.S. Cl. 101/425

(57) ABSTRACT

A method and a device for cleaning a cylinder of a printing press—in particular of a flexographic printing press—are described wherein a layer of ink to be transferred to a web substrate to be printed—such as paper, plastic film and the like—is deposited on said cylinder (1) and wherein a fluid suitable to detach impurities from the area concerned is sent onto the surface of the cylinder (1) to be cleaned and a suction is provided to remove said impurities from the cylinder surface, said cleaning fluid being vapour.

The present invention refers to a method and a device for cleaning a cylinder of a printing press, particularly of a flexographic printing press.

As is known, in a flexographic printing press there is a large-sized cylinder, on which is passed a web of material to be printed—such as paper, plastic or the like—and one or more plate cylinders, which take ink from an inking roll and transfer it to the web of material to be printed.

In these printing presses, according to the material of the web substrate to be printed, the plate cylinders tend to get dirty more or less rapidly, both with the printing ink and with particles that detach from the print substrate, such as dust, fibres and other foreign bodies.

It therefore becomes necessary to clean the print cylinders or plate cylinders so as not to compromise the print quality.

To do this, it is normally necessary to stop the printing process, to remove the cylinder from its seat and to carry out a manual washing or cleaning thereof. All this obviously results in a considerable waste of time.

To overcome this drawback, automatic print cylinder cleaning systems have been proposed, which carry out washing of the cylinder periodically without it being removed from its working seat and without having to stop the machine.

These systems normally consist in a carriage, which is moved longitudinally to the plate cylinder whilst it is in rotation, so as to treat the entire surface area of the cylinder.

A cleaning device of this type is described, for example, in EP 0 742 756 and comprises a cleaning or washing head moveable along the axis of the cylinder and able to spray onto the cylinder a mixture of compressed air and of a liquid which are previously mixed in a mixing chamber disposed upstream of the sprayer nozzle.

Downstream of the sprayer nozzle for fluid under pressure, in the direction of rotation of the cylinder, suction is provided to remove the impurities detached by the fluid under pressure.

Such a solution proves somewhat complex due to the presence of the mixing pre-chamber, and furthermore does not ensure drying or complete removal of the washing liquid, residues of which can remain on the cylinder.

WO 01/54 909 describes a device for cleaning a plate cylinder, wherein the nozzle for spraying the washing liquid onto the cylinder is disposed inside a suction chamber, downstream of which at least one suction drying chamber for removing the residues of washing liquid from the surface of the cylinder is provided.

This solution also proves somewhat complex due to the fact that the sprayer nozzle must be kept inside a closed suction chamber and in any case it does not ensure complete removal of the residues of washing liquid.

Object of the invention is to eliminate the drawbacks of already known systems for cleaning a print cylinder.

In particular, an object of the invention is to provide a method and a device for cleaning a cylinder of a printing press that allow perfect cleaning of the cylinder surface to be performed without leaving residues of the washing fluid thereon.

Another object of the invention is to provide a method and a device that are cheap and simple to achieve.

Another object of the invention is to provide a method and a device that can be used both with solventless inks and with solvent-based inks and UV inks.

These and other objects are achieved with the method and the device according to the invention, which have the characteristics of independent claims 1 and 8, respectively.

Advantageous embodiments of the invention are apparent from the dependent claims.

Substantially, according to the invention, a jet of vapour to the surface to be cleaned and a subsequent suction to remove the impurities removed from the cylinder are provided.

Downstream of the suction there is advantageously provided a jet of air under pressure to dry the treated surface.

The vapour sprayer nozzle is disposed inside a chamber that surrounds it and the suction chamber has an arched profile, which extends for an angle of about 180° around and in front of the sprayer nozzle.

The jet of air on the other hand is shaped as a continuous or discontinuous blade.

The vapour used for washing the plate cylinder is simple steam, in the most common case in which solventless inks are used for printing.

However, in the case of solvent-based or UV inks, other substances in a liquid or vapour state can be added to the steam, in particular suitable solvents compatible with the different types of inks for removing the inks used for printing and the impurities deposited on the cylinder.

In addition to the excellent cleaning results that can be obtained with the use of vapour, it has surprisingly been noted that said vapour does not cause a rise in temperature of the cylinder, which might have adversely affected the printing process.

Further characteristics of the invention will be made clearer by the detailed description that follows, referring to a purely exemplary and therefore non limiting embodiment thereof, illustrated in the appended drawings, in which:

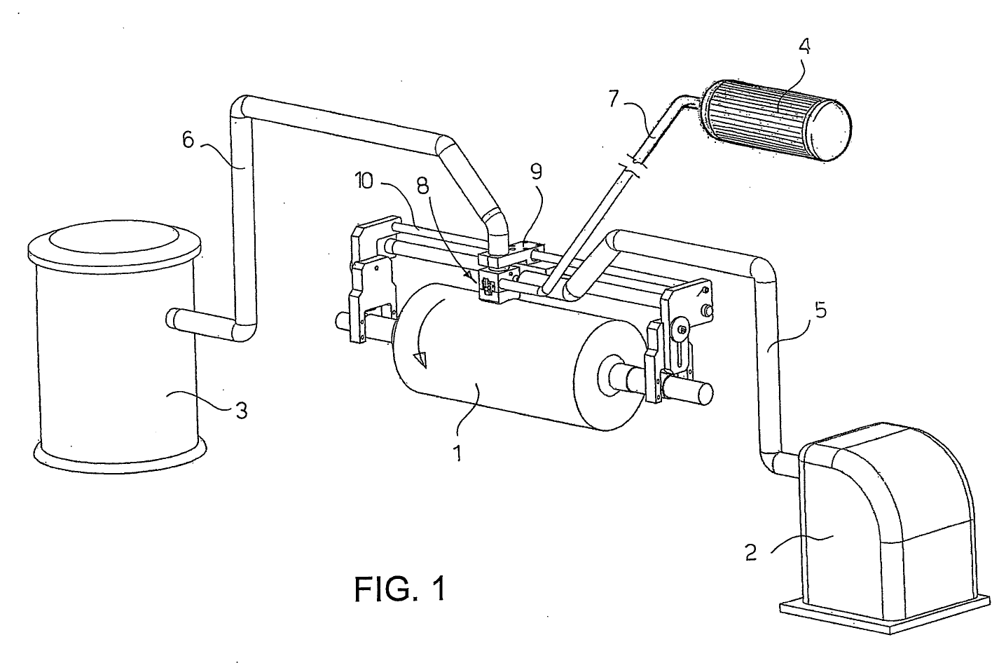

FIG. 1 is a diagrammatic axonometric view showing the device according to the invention applied to a plate cylinder;

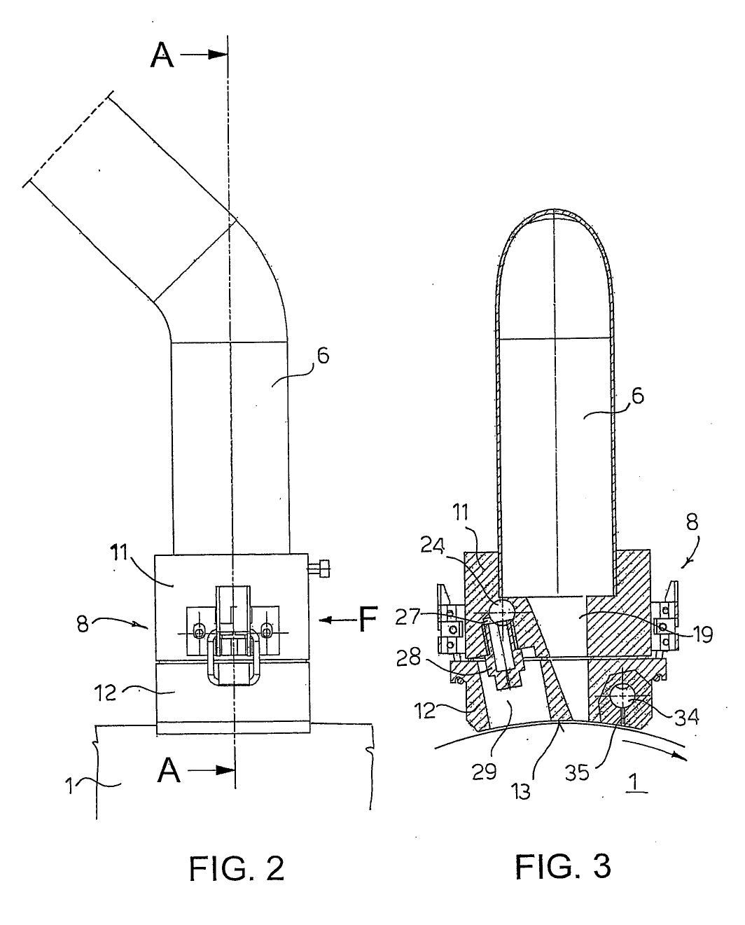

FIG. 2 is a partial front view of the device of FIG. 1;

FIG. 3 is a section along the line A-A of FIG. 2;

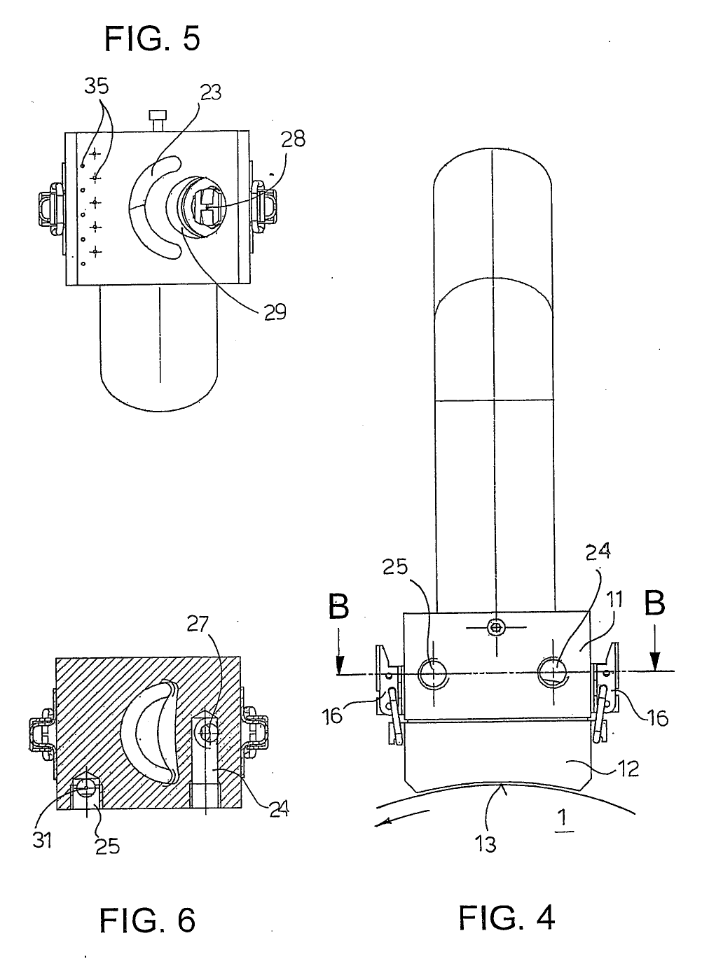

FIG. 4 is a view from the right-hand side of FIG. 2, according to arrow F;

FIG. 5 is a bottom view of the cleaning head of FIG. 4;

FIG. 6 is a section along the line B-B of FIG. 4;

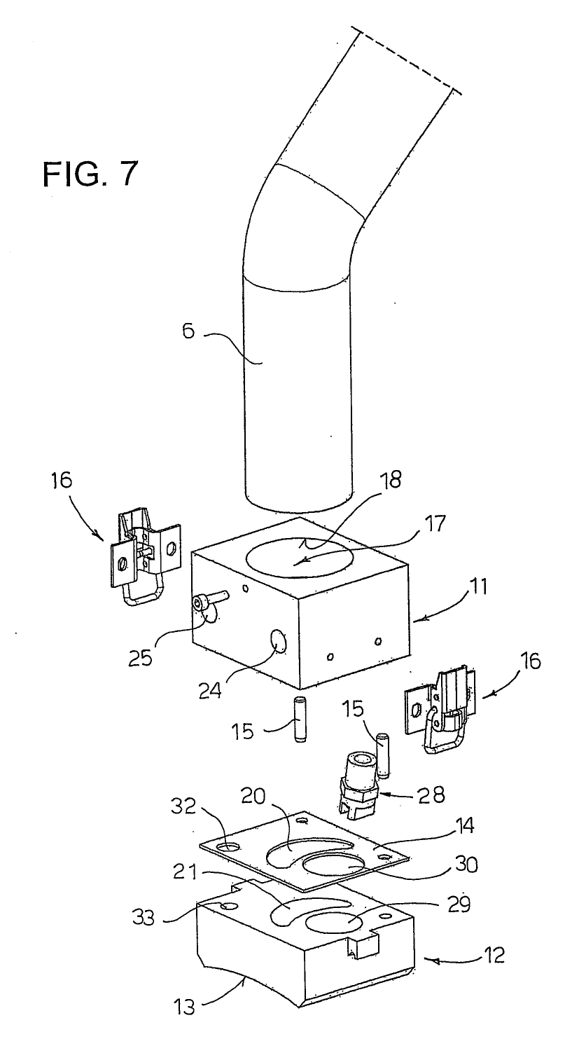

FIG. 7 is an exploded view of the cleaning head.

With reference to the appended figures, and in particular to FIG. 1, the numeral 1 denotes a print cylinder or plate-carrying cylinder, which hereunder will also be called plate cylinder, that is a cylinder on which the printing ink is distributed to be transferred to a substrate of web material, not shown, which is passed on a cylinder, normally of a large size, disposed to the rear of the cylinder 1, and also not shown.

Obviously there may be more than one cylinder 1, disposed along the periphery of the impression cylinder, according to the printing to be done on the web substrate.

FIG. 1 shows diagrammatically a vapour supplier 2 that is a boiler for vapour generation with an accumulation tank, an aspirator 3 and a compressor 4, respectively to send the vapour and to suck and send compressed air, through respective pipes 5, 6, 7, in a cleaning head 8, which will be better described later.

The head 8 is supported by a plate 9, which can slide linearly along a rod 10 so as to move in both directions along the axis of the cylinder 1. In this manner, whilst the cylinder is rotating in the direction of the arrow shown thereon, the head 8 performs cleaning thereof in the manner that will be described below.

Obviously operation of the cleaning head 8 and movement thereof along the axis of the cylinder 1 are established according to the web substrate to be printed and to the ink used.

Considering now the subsequent figures, it can be seen that the cleaning head 8 comprises an upper body 11, substantially parallelepiped in shape, with suitable apertures for the passage of working fluids and a lower body 12, also provided with suitable apertures and ending at the bottom in a circular cradle shape 13, such as to adapt to the surface of the cylinder 1 to be treated (see in particular FIGS. 3 and 7).

The two bodies 11 and 12 are joined together, after interposition of a suitably perforated gasket 14 and of centring pins 15, by means of a pair of lever hooks 16, operation of which can be clearly understood from the figures.

In the upper body 11 a vertical through opening 17 is provided, having at the top a circular section 18 designed to house the end of the duct 6 coming from the aspirator 3 and having at the bottom an arched profile 19 with which corresponding apertures with an arched profile (20, 21), provided respectively in the gasket 14 and in the lower body 12 (FIG. 7), are coupled.

The arched aperture 21 provided in the lower body 12 of the cleaning head takes on a substantially semi-circular shape 23 at the lower face 13 of said body 12 (FIG. 5).

On a side wall of the upper body 11 of the cleaning head two holes (24, 25) for connecting respectively the duct 5 coming from the vapour supplier 2 and the duct 7 coming from the compressor 4 are also provided.

The hole 24, substantially horizontal, communicates with a vertical hole 27, slightly inclined, in which a vapour sprayer nozzle 28 is fixed, whose end houses in a substantially cylindrical chamber 29 provided in the lower body 12, remaining at a suitable distance from the surface of the cylinder 1 to be cleaned.

A corresponding substantially circular hole 30 is provided in the gasket for passage of the nozzle 28.

The hole 25 for connecting the duct 7 of the compressor 4, formed in the upper body 11, is also substantially horizontal and communicates with a substantially vertical hole 31 (FIG. 6) with which coincide a hole 32 formed in the gasket 14 and a vertical hole 33 formed in the lower body 12 (FIG. 7), which in turn communicates with a horizontal duct 34 (FIG. 3) which distributes the air through a series of offset holes 35 opening onto the lower surface 13 of the lower body 12 of the cleaning head (FIG. 5) and oriented along the axis of the cylinder 1.

Having described the structure of the device according to the invention, its operation should be obvious.

Whilst the cylinder 1 rotates in the direction of the arrows shown on the drawings, the nozzle 28, disposed in the chamber 29 with its axis slightly inclined with respect to the vertical, emits a jet of vapour inclined by about 100 with respect to the perpendicular to the surface of the cylinder 1, thus causing the ink residues and all other impurities to be detached from said surface.

These impurities are sucked downstream of the nozzle 28 through the slot 23, whose semicircular shape in front of the nozzle 28 is optimal for removing said impurities and for preventing them from being dispersed sideways.

To finish off, a jet of compressed air is sent onto the surface of the cylinder through the two series of offset holes 35, again disposed downstream of the slot 23, to eliminate any residual moisture and to obtain a complete drying.

With the common water-based inks which are normally used in flexographic printing of the substrate of web material, the nozzle 28 sprays steam onto the surface of the cylinder 1 to remove said inks.

If solvent-based inks or UV inks, which cannot be removed with steam alone, are used, suitable solvents—in the liquid state or also in the vapour state—that are compatible with the various types of ink are added thereto. Glycol or ethyl acetate-based solvents mixed in water in percentages of 30-50% are indicated as a limiting example of said solvents.

As stated previously, it has surprisingly been noted that the use of vapour, contrary to what might have been thought, does not cause any increase in temperature of the surface of the cylinder 1 to be cleaned, whose effect on printing would have been unpredictable.

Of course, the invention is not limited to the particular embodiment described herein and illustrated in the appended drawings, but numerous modifications of detail within the reach of a person skilled in the art can be made thereto, without thereby departing from the scope of said invention as defined by the claims that follow.

1. A method for cleaning a cylinder (1) of a printing press, wherein a layer of ink to be transferred to a web substrate to be printed—such as paper, plastic film and the like—is deposited on said cylinder (1) and wherein a cleaning vapour fluid able to detach impurities from the area concerned is sent onto the surface of the cylinder (1) to be cleaned and a suction to remove said impurities from the cylinder surface is provided, characterised in that said vapour is sent under pressure in a slightly inclined direction with respect to the perpendicular to the cylinder surface (1) through a nozzle (28) housed in a cavity (29) of a cleaning head (8) and in that said suction takes place immediately downstream of the vapour jet through a slot (23) in said cleaning head, partially surrounding the nozzle (28), and placed outside said cavity (29).

2. A method according to claim 1, characterised in that said vapour is steam.

3. A method according to claim 2, characterised in that said steam is added with suitable solvents in the liquid or vaporous state, compatible with the various types of ink, for removal of solvent-based inks or UV inks.

4. A method according to claim 3, wherein said solvents are glycol or ethyl acetate based, mixed in water in percentages of 30-50%.

5. A method according to claim 1, characterised in that said suction slot has a curved profile extending over an arc of about 180°.

6. A method according to claim 1, characterised in that downstream of said suction a jet of pressurized air for drying of the cylinder is provided.

7. A device for cleaning a cylinder of a printing press, in particular of a flexographic printing press, comprising a head (8) mounted longitudinally moveable along the axis of the cylinder (1) and comprising a nozzle (28) for sending a washing vapour fluid onto the zone of the cylinder surface (1) to be cleaned and a suction means (23) for removal of the impurities that are detached from the cylinder (1), characterized in that said nozzle (8) is supplied with vapour under pressure by a vapour supplier (2), is housed in a cavity (29) of said cleaning head (8) and is oriented so as to direct the jet of vapour in a slightly inclined direction with respect to the perpendicular to the cylinder surface (1) and in that said suction means (23) is a suction slot disposed immediately downstream of the nozzle, partially surrounding it, outside said cavity (29).

8. A device according to claim 8, characterized in that said vapour is steam, possibly added with suitable solvents, in the liquid or vaporous state, compatible with the various types of inks, for removal of solvent-based inks or UV inks.

9. A device according to claim 8, wherein said solvents are glycol or ethyl acetate based, mixed in water in percentages of 30-50%.

10. A device according to claim 8, characterized in that said suction slot (23) has a curved profile extending over an arc of about 180°.

11. A device according to claim 8, characterized in that downstream of said suction slot (23) said cleaning head (8) has a plurality of holes or continuous slots for delivery of a jet of air under pressure onto the cylinder surface (1).

12. A device according to claim 8 characterized in that said cleaning head (8) comprises an upper body (11) and a lower body (12), centred by means of pins (15) and fixed to each other by coupling means (16), said lower body (12) having at the bottom a curved surface which substantially reproduces the curvature of said cylinder (1).

13. A device according to claim 11, characterised in that between said upper (11) and lower (12) body of the head (8) a gasket (14) is interposed, suitably perforated to allow communication between ducts (24, 27) for feeding vapour, ducts (25, 31) for feeding compressed air and a duct (19) for suction of air provided in said upper body 11 and corresponding openings (29) for discharge of vapour, openings (35) for discharge of compressed air and openings (23) for suction of air, provided in said lower body (12).

14. A device according to claim 12, characterised in that said upper body (11) of the cleaning head (8) comprises a circular upper hole (18) for connection of a tube (6) connected to an aspirator (3) and side holes (24, 25) for connection to respective tubes (5, 7) connected respectively to said vapour generator and to a compressor (4).
